(19) United States
(12) Patent Application Publication
(10) Pub. No.: US 2026/0338325 A1
(43) Pub. Date: Oct. 29, 2026

(54) MODULAR, TRANSFORMABLE, INTERCHANGEABLE AND INTERLOCKING HANDICAP ACCESSIBLE BUILDING SYSTEM

(71) Applicant: ToniAnn Galati, Staten Island, NY (US)

(72) Inventor: ToniAnn Galati, Staten Island, NY (US)

(21) Appl. No.: 19/191,701

(22) Filed: Apr. 28, 2025

(51) Int. Cl. F16S 3/04; A61G 5/08; A61H 3/00; A61H 3/04; A63B 69/00; A63G 9/02; E04H 4/00; E04H 4/14

(52) U.S. Cl. CPC F16S 3/04; A61G 5/0875; A61H 3/008; A61H 3/04; E04H 4/0056; E04H 4/144; A61H 2201/0107; A63B 69/0048; A63G 9/02

(57) ABSTRACT

A modular, transformable, interchangeable and interlocking building system to enable the creation of handicap-accessible equipment is disclosed, including a frame constructed of a plurality of support members, the frame is used to construct a plurality of handicap-accessible and handicap modular devices.

### TECHNICAL FIELD

The embodiments generally relate to a modular, transformable, interchangeable and interlocking building system to create various handicap-accessible equipment.

### BACKGROUND

Handicap individuals require various uniquely designed devices in order to move, exercise, perform tasks, and for entertainment. Often, these devices are provided by medical providers and can be costly to purchase, especially if insurance does not cover the particular device. In such, a modular and convenient option is desired to enable individuals to construct various devices which are handicap accessible.

### SUMMARY OF THE INVENTION

This summary is provided to introduce a variety of concepts in a simplified form that is further disclosed in the detailed description of the embodiments. This summary is not intended for determining the scope of the claimed subject matter.

The embodiments disclosed herein relate to a modular, transformable, interchangeable and interlocking building system to enable the creation of handicap-accessible equipment, including a frame constructed of a plurality of support members, the frame is used to construct a plurality of handicap-accessible and handicap modular devices.

The In some aspects, the frame is constructed of PVC, plastics, metals, metal alloys, or similar materials which can be used for indoor and/or outdoor use. Further, the selected materials should be durable to allow for repeated long-term use by the individual.

In some aspects, each of the plurality of support members are interchangeable.

In some aspects, at least a portion of the plurality of support members are configured to pivot to provide a swinging motion to each handicap-accessible and handicap modular device.

In some aspects, a plurality of wheels connected to at least a portion of the plurality of support members.

In some aspects, the plurality of wheels enable mobility of each of the plurality of handicap-accessible and handicap modular devices.

In some aspects, one of the plurality of handicap-accessible and handicap modular devices is configured as a walker.

In some aspects, the plurality of handicap-accessible and handicap modular devices is configured as a wheelchair.

In some aspects, one of the plurality of handicap-accessible and handicap modular devices is configured as a climbing wall.

In some aspects, one of the plurality of handicap-accessible and handicap modular devices is configured as a support structure to support a human.

### BRIEF DESCRIPTION OF THE DRAWINGS

A complete understanding of the present embodiments and the advantages and features thereof will be more readily understood by reference to the following detailed description when considered in conjunction with the accompanying drawings wherein:

FIG. 1 illustrates a perspective view of the modular, transformable, interchangeable and interlocking building system, wherein the system is configured as a climbing wall having a top safety mechanism to attach a multi-point harness securely to secure a handicap child from falling from the climbing wall, according to some embodiments;

FIG. 2 illustrates a perspective view of the modular, transformable, interchangeable and interlocking building system, wherein the system is configured as a handicap-accessible support structure constructed as a handicap walker and/or gait trainer, according to some embodiments;

FIG. 3 illustrates a schematic of the frame and support members of the modular, transformable, interchangeable and interlocking building system, according to some embodiments;

FIG. 4 illustrates a perspective view of the modular, transformable, interchangeable and interlocking building system, wherein the system is configured as a handicap-accessible pool having a handicap accessible ramp with a landing, according to some embodiments;

FIG. 5 illustrates a perspective view of the modular, transformable, interchangeable and interlocking building system, wherein the system is a handicap-accessible structure constructed as a handicap wheelchair swing, according to some embodiments;

FIG. 6 illustrates a perspective view of the modular, transformable, interchangeable and interlocking building system, wherein the system is configured as a mobility tool or similar handicap-accessible device capable of being connected or otherwise attached the handicap wheelchair swing of FIG. 5, according to some embodiments;

FIG. 7 illustrates a perspective view of the modular, transformable, interchangeable and interlocking building system, wherein the system is configured as a mobility tool or similar handicap-accessible device such as a handicap stroller, standard stroller, wheelchair raft, and/or cart with all-terrain wheels to allow the mobility tool to access the beach trails, or other surfaces which require all-terrain tires, according to some embodiments;

FIG. 8 illustrates a perspective view of the modular, transformable, interchangeable and interlocking building system, wherein the system is configured as a mobility tool or similar handicap-accessible device positioned on top of an all-terrain mobility tool, according to some embodiments.

### DETAILED DESCRIPTION

The specific details of the single embodiment or variety of embodiments described herein are set forth in this application. Any specific details of the embodiments described herein are used for demonstration purposes only, and no unnecessary limitation(s) or inference(s) are to be understood or imputed therefrom.

Before describing in detail exemplary embodiments, it is noted that the embodiments re-side primarily in combinations of components related to particular devices and systems. Accordingly, the device components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

In general, the embodiments provided herein relate to a modular, transformable, interchangeable and interlocking building system used for constructing various handicap-accessible structures, ambulatory devices, walkers, wheelchair-type devices, transportation equipment, entertainment equipment, exercise equipment, etc. The building system includes components used to construct a frame having a plurality of support members which are releasable connected with one another and capable of being configured in various shapes, sizes, dimensions and other con-figurations depending on the structure or device the user wishes to construct.

The frame and support members are constructed of PVC, plastics, metals, metal alloys, and/or combinations thereof such that the completed structure is capable of being used in indoor and/or outdoor settings. The materials should be such that they are strong and durable to withstand repeated and long-term use in various environments.

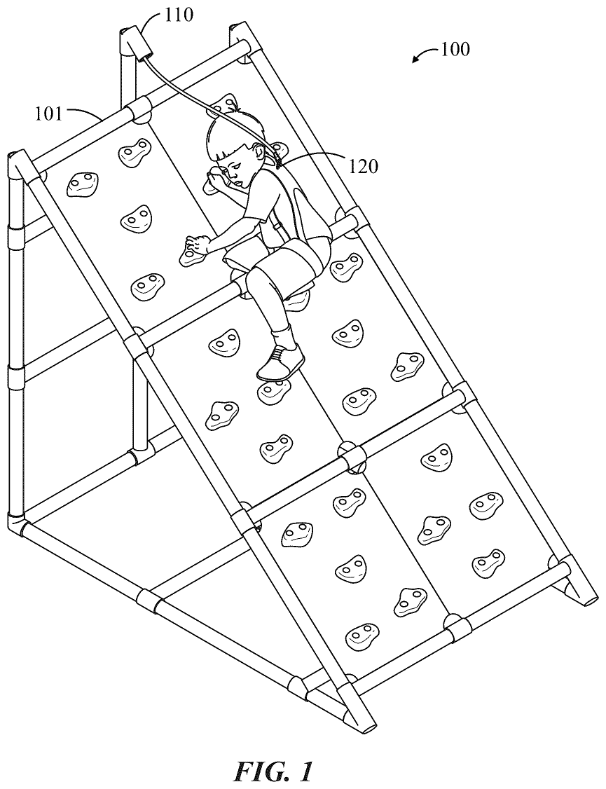

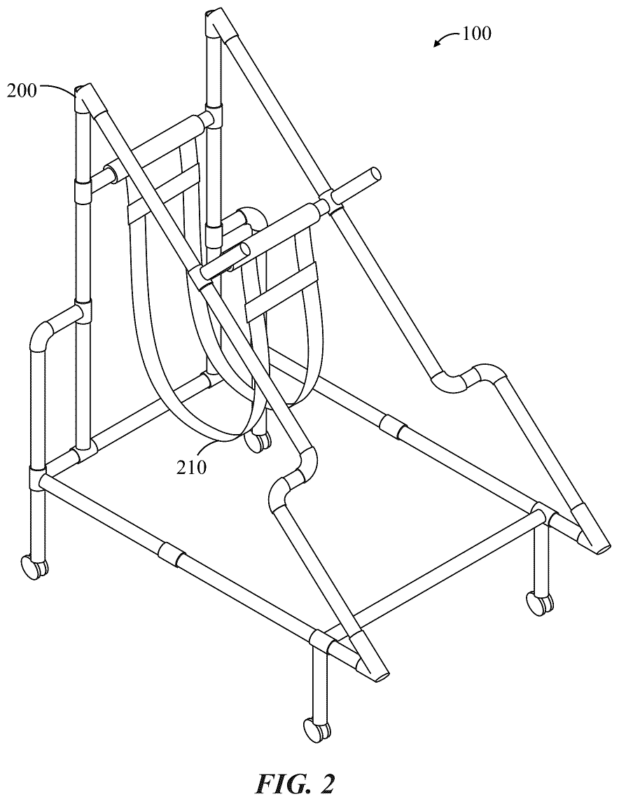

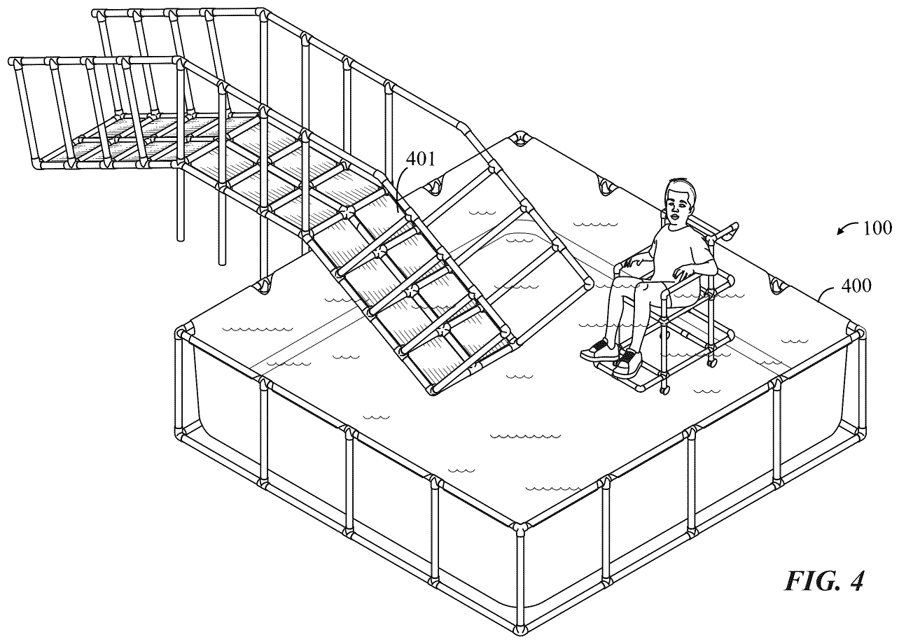

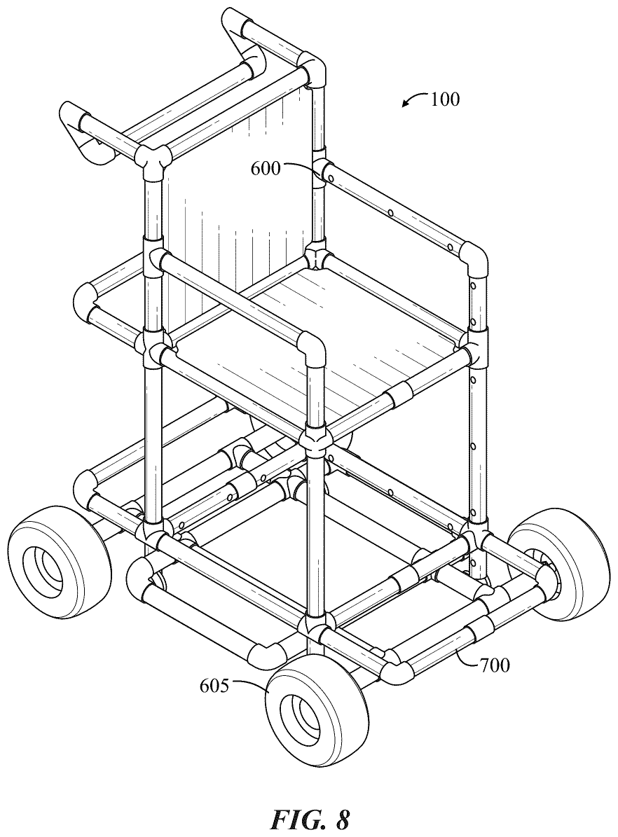

FIGS. 1-8 illustrates examples of structures and devices which can be constructed using the building system 100 disclosed herein. It is to be understood that the illustrated examples are to be non-limiting and only serve as examples for the potential structures and devices which may be constructed. FIG. 1 illustrates a climbing wall 101 which may be constructed using the frame and support members. FIG. 2 illustrates a handicap-accessible support structure 200. FIG. 4 illustrates a handicap-accessible ambulatory device 400.

In specific reference to FIG. 1, the building system 100 includes a safety feature 110 capable of attaching to a multipoint harness 120 worn by a handicap child. The safety feature 110 prevents the child from falling off the rock wall.

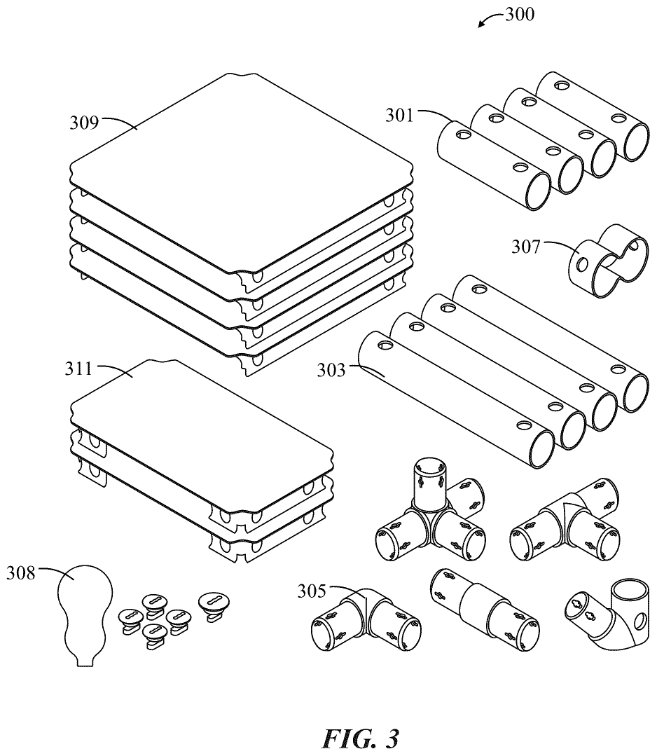

FIG. 3 illustrates a plurality of frame support members 300 used to construct the modular, transformable, interchangeable and interlocking building system 100. Each of the frame and support members 300 can include elongated members 301,303, joints 305, connection components and key 307,308 and surfaces 309,311 which can be connected in various configuration to form the handicap-accessible structures. It is to be understood that each component of the building system can be produced having various shapes, sizes, colors, materials, etc. This may include rectangular members, tubular members, or similar shapes.

In some embodiments, one or more straps 210 (see FIG. 2) can be connected to the building system as needed as a means of retaining the individual in a suitable, safe, and/or stationary position when using the device. The device illustrated in FIG. 2 may be used as a gait trainer, handicap walker, or similar physical therapy, recovery, and/or training device.

In some embodiments, various accessories can be connected to the components of the building system 100. For example, FIG. 1 illustrates foot and hand holds being connected to the frame components to form a climbing wall.

FIG. 4 illustrates the system 100 being constructed and deployed within a pool 400. The system 100 enables the user to access the pool 400 safely through the use of the building system 100 being deployable within the pool 400 as well as the exterior of the pool 400. The pool 400 includes a handicap accessible ramp 401 to allow a handicap individual to easily enter and exit the pool 400. This provides a transformable pool which can be used as a regular pool, handicap-accessible pool, handicap wheelchair ramp and landing. The pool 400 and each element of the pool can be modified to accommodate various needs, such as making the pool and its elements larger, smaller, more deep, more shallow, wider, etc. This modification can also be applied to the handicap accessible ramp 401 which can be modified to different lengths, heights, widths, etc.

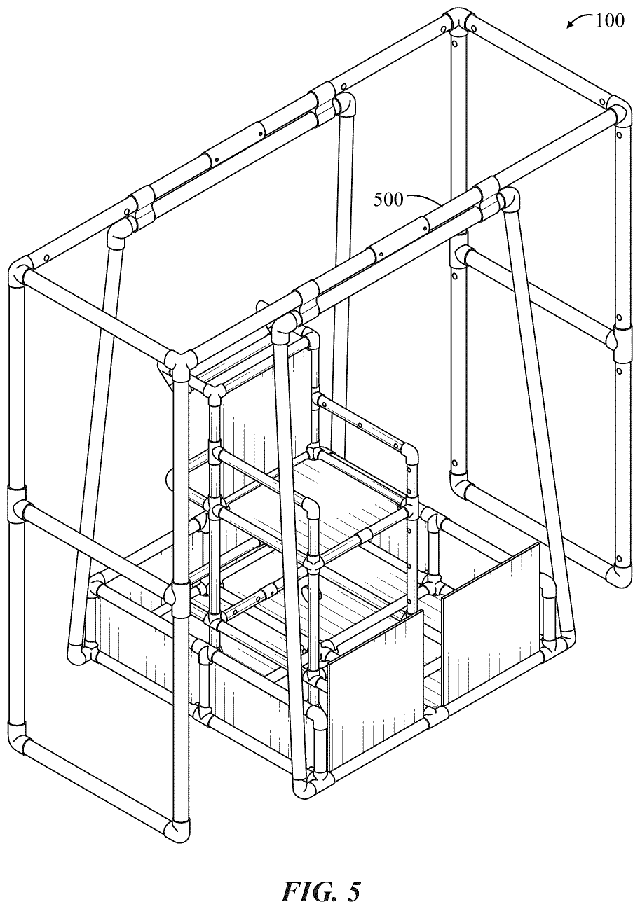

FIG. 5 illustrates the building system 100 being utilized as a handicap-accessible structure 500 wherein the user may safely rest, recreate, or otherwise interact with the structure 500 or other items and/or activities. The structure 500 illustrated in FIG. 5 may be used as a handicap accessible swing having a landing area to support a wheelchair or similar handicap-accessible device. This provides a wheelchair swing that can be used in both indoor and outdoor settings while being fully collapsible or easily deconstructed for storage.

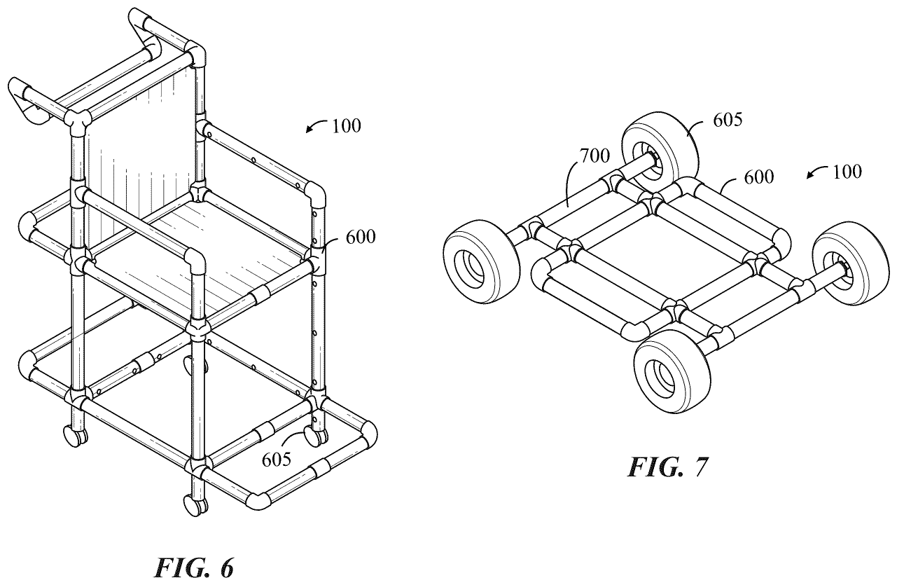

FIGS. 6-8 illustrates a handicap-accessible ambulatory device 600 which can be constructed using the support members. In this example, wheels 605 are connected to enable ease of motion of the device across a ground surface. The ambulatory device 600 can be positioned on a cart 700 which supports the ambulatory device 600 thereon. The cart 700 includes wheels which may be all-terrain wheels that are capable of rolling over uneven, unpaved, etc. surfaces.

In specific reference to FIG. 7, the cart 700 can be any of the following; a stroller raft, walker raft, gait trainer raft, bike raft, tri raft, adaptive bicycle raft, adaptive tri or cycle raft device. The cart can be used to convert any type of accessibility or mobility equipment by securing to the modular transformable raft which has all terrain waterproof balloon bubble wheels.

Unless otherwise defined, all technical and scientific terms used herein have the same meaning as commonly understood by one of ordinary skill in the art to which this invention be-longs. All publications, patent applications, patents, and other references mentioned herein are incorporated by reference in their entirety to the extent allowed by applicable law and regulations. The systems and methods described herein may be embodied in other specific forms without departing from the spirit or essential attributes thereof, and it is therefore desired that the present embodiment be considered in all respects as illustrative and not restrictive. Any headings utilized within the description are for convenience only and have no legal or limiting effect.

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

The foregoing is provided for purposes of illustrating, explaining, and describing embodiments of this disclosure. Modifications and adaptations to these embodiments will be apparent to those skilled in the art and may be made without departing from the scope or spirit of this disclosure.

As used herein and in the appended claims, the singular forms “a”, “an”, and “the” include plural referents unless the context clearly dictates otherwise.

It should be noted that all features, elements, components, functions, and steps described with respect to any embodiment provided herein are intended to be freely combinable and substitutable with those from any other embodiment. If a certain feature, element, component, function, or step is described with respect to only one embodiment, then it should be understood that that feature, element, component, function, or step can be used with every other embodiment described herein unless explicitly stated otherwise. This paragraph therefore serves as antecedent basis and written support for the introduction of claims, at any time, that combine features, elements, components, functions, and steps from different embodiments, or that substitute features, elements, components, functions, and steps from one embodiment with those of another, even if the description does not explicitly state, in a particular instance, that such combinations or substitutions are possible. It is explicitly acknowledged that express recitation of every possible combination and substitution is overly burdensome, especially given that the permissibility of each and every such combination and substitution will be readily recognized by those of ordinary skill in the art.

In many instances entities are described herein as being coupled to other entities. It should be understood that the terms “coupled” and “connected” (or any of their forms) are used inter-changeably herein and, in both cases, are generic to the direct coupling of two entities (without any non-negligible (e.g., parasitic intervening entities) and the indirect coupling of two entities (with one or more non-negligible intervening entities). Where entities are shown as being directly coupled together or described as coupled together without description of any intervening entity, it should be understood that those entities can be indirectly coupled together as well unless the context clearly dictates otherwise.

While the embodiments are susceptible to various modifications and alternative forms, specific examples thereof have been shown in the drawings and are herein described in detail. It should be understood, however, that these embodiments are not to be limited to the particular form disclosed, but to the contrary, these embodiments are to cover all modifications, equivalents, and alternatives falling within the spirit of the disclosure. Furthermore, any features, functions, steps, or elements of the embodiments may be recited in or added to the claims, as well as negative limitations that define the inventive scope of the claims by features, functions, steps, or elements that are not within that scope.

An equivalent substitution of two or more elements can be made for any one of the elements in the claims below or that a single element can be substituted for two or more elements in a claim. Although elements can be described above as acting in certain combinations and even initially claimed as such, it is to be expressly understood that one or more elements from a claimed combination can in some cases be excised from the combination and that the claimed combination can be directed to a subcombination or variation of a subcombination.

It will be appreciated by persons skilled in the art that the present embodiment is not limited to what has been particularly shown and described herein. A variety of modifications and variations are possible in light of the above teachings without departing from the following claims.

What is claimed is:

1. A modular, transformable, interchangeable and interlocking building system to enable the creation of handicap-accessible equipment, comprising:
a frame constructed of a plurality of support members, the frame to construct a plurality of handicap-accessible and handicap modular devices.

2. The system of claim 1, wherein each of the plurality of support members are interchangeable.

3. The system of claim 1, wherein at least a portion of the plurality of support members are configured to pivot to provide a swinging motion to each handicap-accessible and handicap modular device.

4. The system of claim 1, further comprising a plurality of wheels connected to at least a portion of the plurality of support members.

5. The system of claim 4, wherein the plurality of wheels enable mobility of each of the plurality of handicap-accessible and handicap modular devices.

6. The system of claim 1, wherein one of the plurality of handicap-accessible and handicap modular devices is configured as a walker.

7. The system of claim 1, wherein one of the plurality of handicap-accessible and handicap modular devices is configured as a wheelchair.

8. The system of claim 1, wherein one of the plurality of handicap-accessible and handicap modular devices is configured as a climbing wall.

9. The system of claim 1, wherein one of the plurality of handicap-accessible and handicap modular devices is configured as a support structure to support a human.
